(19) United States
(12) Patent Application Publication
(10) Pub. No.: US 2026/0369694 A1
(43) Pub. Date: Nov. 19, 2026

(54) SECONDARY BATTERY

(71) Applicant: Prime Planet Energy & Solutions, Inc., Tokyo (JP)

(72) Inventors: Atsushi KAWAMURA, Kakogawa-shi (JP); Shota YANASE, Kobe-shi (JP)

(21) Appl. No.: 19/654,462

(22) Filed: Apr. 22, 2026

(30) Foreign Application Priority Data
Apr. 28, 2025 (JP) 2025-074915

(51) Int. Cl. H01M 10/0587; B60L 50/64; H01M 4/75; H01M 50/463

(52) U.S. Cl. CPC H01M 10/0587; H01M 4/75; H01M 50/463; B60L 50/64

(57) ABSTRACT

A battery includes a wound electrode body with strip-shaped cathode and anode wound in a longitudinal direction via a separator. The cathode has a laminated structure including a cathode current collector and a cathode active material layer. The anode has a laminated structure including an anode current collector and an anode active material layer, a facing portion facing the cathode active material layer via the separator, and a non-facing end portion not facing the cathode active material layer via the separator. The anode active material layer has a recessed portion where a surface of the anode active material layer is regressed from the separator in a boundary region between the facing and the non-facing end portions. In the anode active material layer, the recess depth of the recessed portion in an outermost peripheral region of the electrode body is larger than in an innermost peripheral region of the electrode body.

### CROSS REFERENCE TO RELATED APPLICATION

This application claims priority based on Japanese Patent Application No. 2025-074915 filed on Apr. 28, 2025, which is entirely incorporated herein by reference.

### BACKGROUND

The present disclosure relates to a secondary battery.

In recent years, rechargeable secondary batteries such as lithium ion secondary batteries have been used as portable power sources for mobile devices or the like and as vehicle drive power sources for battery electric vehicles (BEV), hybrid electric vehicles (HEV), plug-in hybrid electric vehicles (PHEV), or the like. A secondary battery includes an electrode body including a cathode and an anode, and an electrolytic solution permeating the electrode body. The cathode and anode each have an active material layer responsible for a battery reaction during charging and discharging. In a case of a lithium ion secondary battery, during charging and discharging, a battery reaction occurs on a cathode and an anode of an electrode body, and insertion and extraction of lithium (Li) ions proceed between active material layers of the two electrodes. Such a technology for secondary batteries is described e.g. in Japanese Patent Application Laid-Open No. 2018-190624.

### SUMMARY

As one form of an electrode body for a secondary battery, a wound electrode body is known. A wound electrode body comprises a strip-like cathode, a strip-like anode, and a strip-like separator, with the cathode and anode wound in a longitudinal direction via the separator. In the wound electrode body, an anode active material layer may be formed wider than a cathode active material layer in a width direction perpendicular to the longitudinal direction in some cases. In this case, the anode active material layer has a region that faces the cathode active material layer via the separator (facing portion), and a region that does not face the cathode active material layer (non-facing end portion). This configuration helps to prevent or suppress metallic lithium from precipitating on an end portion of the anode active material layer during charging. However, in the anode active material layer wider than the cathode active material layer, Li ions inserted into the facing portion during charging diffuse into the non-facing end portion. This Li ion diffusion is undesirable because it causes battery voltage drop.

The present disclosure has been invented under the above circumstances, and an object of the present disclosure is to provide a secondary battery suitable for suppressing Li-ion from precipitating in the anode active material layer while suppressing Li ions from diffusing into the cathode active material layer-non-facing end portion in the anode active material layer.

The secondary battery disclosed herein is a secondary battery including a wound electrode body. The wound electrode body includes a strip-like cathode, a strip-like anode, and a strip-like separator, with the cathode and anode wound in the longitudinal direction via the separator. The cathode has a laminated structure including a cathode current collector and a cathode active material layer. The anode has a laminated structure including an anode current collector and an anode active material layer. The anode active material layer includes a facing portion that faces the cathode active material layer via the separator, and a non-facing end portion that does not face the cathode active material layer via the separator. The anode active material layer has a recessed portion. The recessed portion is a portion where the surface of the anode active material layer is regressed from the separator in a boundary region between the facing portion and the non-facing end portion of the anode active material layer. In the anode active material layer, the recess depth of the recessed portion in the outermost peripheral region of the wound electrode body is larger than the recess depth of the recessed portion in the innermost peripheral region of the wound electrode body.

In the secondary battery having this configuration, the anode active material layer in the anode of the electrode body includes a non-facing end portion that does not face the cathode active material layer via the separator, as described above. For ensuring a positional relationship where the entire area of the cathode active material layer faces the anode active material layer, it is suitable that the anode active material layer further includes the non-facing end portion outside the region (facing portion) that faces the cathode active material layer (this is suitable for ensuring the tolerance of the facing positional relationship between the anode active material layer and the cathode active material layer when a winding deviation occurs in the wound electrode body, and therefore helps to ensure the productivity of the wound electrode body or the secondary battery). Furthermore, for uniformizing Li ions inserted into the anode active material layer during secondary battery charging, it is suitable that the anode active material layer further includes the non-facing end portion outside the region (facing portion) that faces the cathode active material layer. Thus, this helps to suppress Li ions from precipitating in the anode active material layer (when the edge of the anode active material layer is within the cathode active material layer-facing region, a density of the inserted Li ions tends to increase locally on this edge to enhance Li ion precipitation).

The anode active material layer has a recessed portion where the surface of the anode active material layer is regressed or apart from the separator in the boundary region between the facing portion and the non-facing end portion, as described above. This configuration is suitable for narrowing the Li ion migration pathway from the facing portion to the non-facing end portion in the anode active material layer to suppress diffusion of Li ions. Also, such suppression of the Li ion diffusion helps to suppress anode potential rise, thereby suppressing voltage drop due to self-discharge in the secondary battery.

Furthermore, in the recessed portion of the anode active material layer, as described above, a depth in the outermost peripheral region of the wound electrode body is larger than a depth in the innermost peripheral region. According to this configuration, when the recessed portion has a groove shape, the electrolytic solution retained in the recessed portion of the anode active material layer in the outermost peripheral region suppresses the electrolytic solution from leaking outside the electrode body, thereby suppressing high-rate degradation of the electrode body.

As described above, the secondary battery according to the present disclosure is suitable for suppressing Li ion precipitation in the anode active material layer and also suppressing Li ion diffusion into the cathode active material layer-non-facing end portion in the anode active material layer.

### BRIEF DESCRIPTION OF THE DRAWINGS

FIG. 1 is a schematic sectional view illustrating the internal structure of a secondary battery according to an embodiment of the present invention;

FIG. 2 is a schematic diagram illustrating a configuration of an electrode body provided in the secondary battery illustrated in FIG. 1;

FIG. 3 is a schematic sectional view of one laminated unit in the electrode body illustrated in FIG. 2, with some parts omitted;

FIGS. 4A to 4C show enlarged schematic sectional views each illustrating a recessed portion of an anode active material layer and its vicinity illustrated in FIG. 3;

FIG. 5 shows a pressing step of a wound electrode body;

FIG. 6 is an enlarged schematic sectional view illustrating a variation for the recessed portion and its vicinity; and

FIG. 7 shows measurement data for a sectional shape of the recessed portion in Example 1.

### DETAILED DESCRIPTION

A lithium ion secondary battery will be explained below with reference to the drawings as an embodiment of the secondary battery according to the present invention. In this specification, the term “secondary battery” refers to a general rechargeable power storage device. The present invention can be implemented based on the content disclosed herein and the common technical knowledge in the field. Matters that are not specifically mentioned herein but necessary for implementing the present invention (e.g. general configuration and manufacturing process of a secondary battery that does not characterize the present invention) can be understood as matters designed by those skilled in the art on the basis of the prior art in the field.

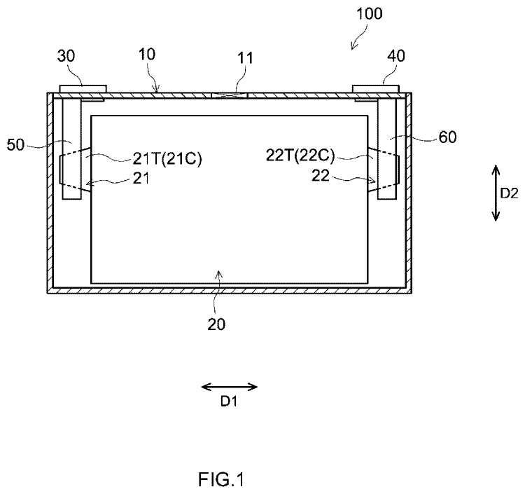

FIG. 1 is a schematic sectional view illustrating the internal structure of a battery 100 as an embodiment according to the present invention. The battery 100 includes a case 10, an electrode body 20 (electrode assembly), a cathode terminal 30 (positive terminal), an anode terminal 40 (negative terminal), and a nonaqueous electrolytic solution (not illustrated). In this embodiment, the battery 100 is a lithium ion secondary battery.

The case 10 is a housing for the battery 100 and accommodates the electrode body 20 and the nonaqueous electrolytic solution. In this embodiment, the case 10 has a flat rectangular parallelepiped (e.g. square) outer shape extending in a first direction D1. In this embodiment, the case 10 has a height in a second direction D2 orthogonal to the first direction D1 and a thickness in a direction orthogonal to both the first direction D1 and the second direction D2. Examples of a constituent material for the case 10 include aluminum, an aluminum alloy, iron, and an iron alloy. From the viewpoint of achieving both weight saving and a required rigidity for the case 10, the constituent material for the case 10 is preferably aluminum or an aluminum alloy.

The case 10 includes a safety valve 11. In this embodiment, the safety valve 11 is located between the cathode terminal 30 and the anode terminal 40 on the top surface of the case 10 in FIG. 1. The safety valve 11 is a thin-walled portion configured to rupture when a gas pressure inside the case 10 rises above a predetermined value. When the safety valve 11 ruptures, the gas inside the case 10 is discharged outside the case 10 to prevent or suppress additional pressurization inside the case 10. The case 10 has an injection hole (not illustrated) for injecting the nonaqueous electrolytic solution into the case 10. The injection hole is sealed by a sealing member after injection of the nonaqueous electrolytic solution.

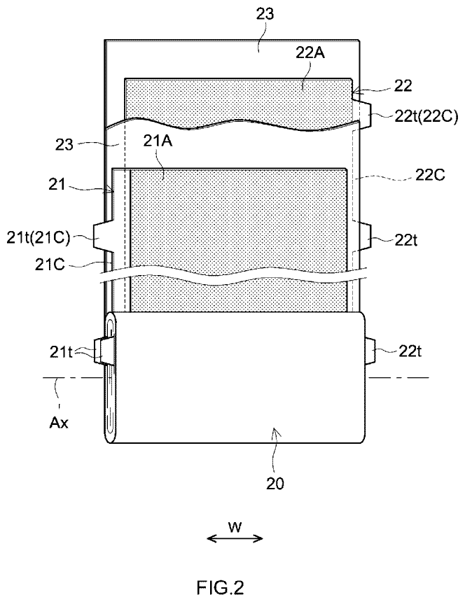

FIG. 2 is a schematic diagram illustrating a configuration of the electrode body 20. The electrode body 20 includes a laminated structure with a cathode 21 (positive electrode), an anode 22 (negative electrode), and a separator 23 interposed therebetween. The electrode body 20 is a flat wound electrode body, which is formed by winding an elongated sheet-like laminate (having a width perpendicular to its longitudinal direction) with the elongated sheet-like cathode 21, the elongated sheet-like separator 23, the elongated sheet-like anode 22, and an additional elongated sheet-like separator 23 arranged in this order. After winding, the wound electrode body is flattened by pressing. This electrode body 20 (wound electrode body) is accommodated in the case 10 with its winding axis Ax extending in the first direction D1 in FIG. 1. Instead of this configuration described above, the electrode body 20 may be a laminated electrode body in which a quadrate cathode and a quadrate anode are laminated in a state insulated from each other.

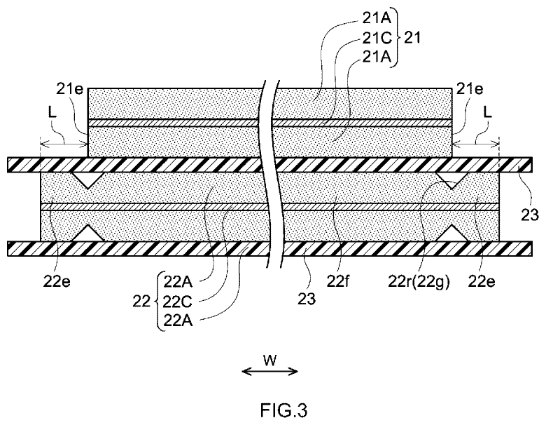

The cathode 21 has a laminated structure including a cathode current collector 21C and a cathode active material layer 21A (positive active material layer). In this embodiment, the cathode 21 has the cathode active material layers 21A on both sides of the cathode current collector 21C as illustrated in FIG. 3 (FIG. 3 is a schematic sectional view of one laminated unit in the electrode body 20, with some parts omitted).

Examples of the cathode current collector 21C include a conductive metal foil and a resin sheet with a double-sided conductive metal layer. Examples of the conductive metal for the cathode current collector 21C include aluminum, an aluminum alloy, nickel, titanium, and stainless steel. Above all, aluminum is preferable.

From the viewpoint of thinning the cathode current collector 21C, the cathode current collector 21C has a thickness of preferably 20 μm or smaller, more preferably 15 μm or smaller, even more preferably 10 μm or smaller. For ensuring a high energy density in the electrode body 20 or the battery 100, it is advantageous to thin the cathode current collector 21C. From the viewpoint of ensuring the strength of the cathode current collector 21C, the cathode current collector 21C has a thickness of preferably 3 μm or larger, more preferably 5 μm or larger, even more preferably 7 μm or larger.

The cathode active material layer 21A contains a cathode active material (positive active material) capable of reversibly storing and releasing charge carriers. The cathode active material is preferably a lithium transition metal composite oxide. Specific examples of this oxide include a lithium-cobalt composite oxide, a lithium-manganese composite oxide, a lithium-nickel composite oxide, a lithium-nickel-manganese composite oxide, a lithium-nickel-cobalt composite oxide, and a lithium-nickel-cobalt-manganese composite oxide. The cathode active material layer 21A may contain additives other than the cathode active material. Examples of the additives include a conductive material, a binder, and trilithium phosphate. Examples of the conductive material include acetylene black, Ketjen black, graphite, and carbon nanotube. Examples of the binder include a fluororesin such as polyvinylidene fluoride (PVDF) and a rubber material such as styrene-butadiene rubber (SBR).

From the viewpoint of ensuring the battery capacity of the battery 100, the cathode active material layer 21A has a thickness of preferably 10 μm or larger, more preferably 20 μm or larger, even more preferably 30 μm or larger. From the viewpoint of ensuring good rate characteristics for the battery 100, the cathode active material layer 21A has a thickness of preferably 200 μm or smaller, more preferably 150 μm or smaller, even more preferably 100 μm or smaller.

In this cathode 21, the cathode current collector 21C has multiple tabs 21t on one end (left end in FIG. 2) of the electrode body 20 or cathode 21 in the width direction W in this embodiment. The width direction W refers to a direction perpendicular to the longitudinal direction of the elongated sheet-like laminate. In the cathode current collector 21C, the tabs 21t are included in an exposed region where the cathode active material layer 21A is not laminated. In the wound electrode body 20, the multiple tabs 21t are stacked in the laminating direction of the laminated structure of the electrode body 20 to form the cathode tab portion 21T (illustrated in FIG. 1) (in the cathode current collector 21C, the tabs 21t are provided in that arrangement). The cathode tab portion 21T functionally serves as the current collection portion in the cathode 21. In this integrally stacked state, the tabs 21t are connected to cathode current collection plates 50 (cathode current collection plates 50 are provided on each cathode tab portion 21T). Examples of a constituent material for the cathode current collection plate 50 include aluminum and an aluminum alloy. Examples of the method for connecting the cathode current collection plates 50 to the cathode tab portions 21T in the cathode 21 include ultrasonic joining and laser welding.

The anode 22 has a laminated structure including an anode current collector 22C and an anode active material layer 22A (negative active material layer). In this embodiment, the anode 22 has the anode active material layers 22A on both sides of the anode current collector 22C, as illustrated in FIG. 3.

Examples of the anode current collector 22C include a conductive metal foil and a resin sheet with a double-sided conductive metal layer. Examples of the conductive metal for the anode current collector 22C include copper, a copper alloy, nickel, and stainless steel, and a copper foil is preferable.

From the viewpoint of thinning the anode current collector 22C, the anode current collector 22C has a thickness of preferably 20 μm or smaller, more preferably 15 μm or smaller, even most preferably 10 μm or smaller. For ensuring a high energy density in the electrode body 20 or battery 100, it is advantageous to thin the anode current collector 22C. From the viewpoint of ensuring the strength of the anode current collector 22C, the anode current collector 22C has a thickness of preferably 3 μm or larger, more preferably 5 μm or larger, even more preferably 7 μm or larger.

The anode active material layer 22A contains an anode active material (negative active material) capable of reversibly storing and releasing charge carriers. Examples of the anode active material include a carbon material such as graphite, hard carbon, and soft carbon. The graphite may be natural graphite or artificial graphite. The anode active material layer 22A may contain additives other than the anode active material. Examples of the additives include a binder and a thickener. Examples of the binder include a rubber material such as styrene-butadiene rubber (SBR) and a fluororesin such as polyvinylidene fluoride (PVDF). Example of the thickener includes a cellulose material such as carboxymethylcellulose (CMC).

From the viewpoint of achieving a high energy density and a high capacity for the battery 100, the density of the anode active material layer 22A is preferably 1.0 g/cm³ or higher, more preferably 1.2 g/cm³ or higher, even more preferably 1.4 g/cm³ or higher. From the viewpoint of ensuring good rate characteristics for the battery 100, the density of the anode active material layer 22A is preferably 2.0 g/cm³ or lower, more preferably 1.8 g/cm³ or lower, even more preferably 1.6 g/cm³ or lower.

From the viewpoint of ensuring the battery capacity of the battery 100, the anode active material layer 22A has an average thickness of preferably 50 μm or larger, more preferably 70 μm or larger, even more preferably 80 μm or larger. From the viewpoint of ensuring good rate characteristics for the battery 100, the anode active material layer 22A has an average thickness of preferably 200 μm or smaller, more preferably 150 μm or smaller, even more preferably 100 μm or smaller.

The anode active material layer 22A includes a facing portion 22f and non-facing end portions 22e. The anode active material layer 22A has the non-facing end portions 22e on both ends in the width direction W. The facing portion 22f is a region that faces the cathode active material layer 21A via the separator 23 in the anode active material layer 22A. The non-facing end portions 22e are regions that do not face the cathode active material layer 21A via the separator 23 in the anode active material layer 22A. The configuration that the anode active material layer 22A further includes the non-facing end portions 22e outside the facing portion 22f that faces the cathode active material layer 21A helps to suppress defects caused by winding deviation when winding the cathode 21, the anode 22, and the separator 23 interposed therebetween. Furthermore, this configuration is suitable for uniformizing Li ions inserted into the anode active material layer 22A during charging of the battery 100, thereby helping to suppress Li ions from precipitating in the anode active material layer 22A.

In the width direction W of the electrode body 20, a protrusion length L of the non-facing end portion 22e from an edge 21e of the cathode active material layer 21A is preferably 0.5 mm or larger, more preferably 1.0 mm or larger, even more preferably 1.2 mm or larger. This configuration is preferable for suppressing Li ion precipitation in the anode active material layer 22A. From the viewpoint of ensuring the volume energy density of the electrode body 20, the protrusion length L is preferably 3.0 mm or smaller, more preferably 2.6 mm or smaller, even more preferably 2.3 mm or smaller.

The anode active material layer 22A has a recessed portion 22r. The recessed portion 22r is a region where the surface of the anode active material layer 22A on the cathode active material layer 21A side is regressed or apart from the separator 23 in the boundary region between the facing portion 22f and the non-facing end portion 22e. In this embodiment, the anode active material layer 22A in the wound electrode body 20 has the recessed portion 22r over its entire length in the longitudinal direction. The region over the entire length includes the outermost peripheral region and the innermost peripheral region of the wound electrode body 20. The anode active material layer 22A having this recessed portion 22r is suitable for narrowing the Li ion migration pathway from the facing portion 22f to the non-facing end portion 22e of the anode active material layer 22A to suppress Li ion diffusion. Such suppression of the Li ion diffusion also helps to suppress anode potential rise to suppress voltage drop due to self-discharge in the battery 100.

In this embodiment, the recessed portion 22r is a groove portion 22g having a groove shape opened to the separator 23 side. The nonaqueous electrolytic solution can stored in the groove portion 22g. The anode active material layer 22A having this groove portion 22g is suitable for suppressing release of the nonaqueous electrolytic solution permeating the electrode body 20 to the outside of the electrode body 20. Suppression in release of the nonaqueous electrolytic solution from the electrode body 20 helps to suppress increase in an internal resistance (high-rate degradation) due to high rate charging and discharging in the battery 100.

From the viewpoint of suppressing the Li ion diffusion, the groove portion 22g (recessed portion 22r) has a depth of preferably 1 μm or larger, more preferably 5 μm or larger, even more preferably 10 μm or larger. From the viewpoint of suppressing the active material from being detached from the anode active material layer 22A, the groove portion 22g has a depth of preferably 70 μm or smaller, more preferably 60 μm or smaller, even more preferably 55 μm or smaller. The depth of the groove portion 22g refers to a length (dimension) of the groove portion 22g in the thickness direction of the anode active material layer 22A.

From the viewpoint of suppressing the Li ion diffusion described above, the groove portion 22g (recessed portion 22r) has a width of preferably 0.3 mm or larger, more preferably 0.7 mm or larger, even more preferably 1.0 mm or larger. From the viewpoint of suppressing detachment of the active material, the groove portion 22g has a width of preferably 3.5 mm or smaller, more preferably 3.2 mm or smaller, even more preferably 3.0 mm or smaller. The width of the groove portion 22g refers to a length (dimension) of the groove portion 22g between the opening ends in a direction perpendicular to the extending direction of the groove portion 22g.

A ratio (d/T) of the depth d (recess depth) of the groove portion 22g to the thickness T of the anode active material layer 22A is preferably 0.02 or higher, more preferably 0.10 or higher, even more preferably 0.20 or higher. This configuration is preferable for suppressing Li ion diffusion from the facing portion 22f to the non-facing end portion 22e of the anode active material layer 22A. The ratio (d/T) is preferably 0.70 or lower, more preferably 0.65 or lower, even more preferably 0.60 or lower. This configuration is preferable from the viewpoint of suppressing the active material from being detached.

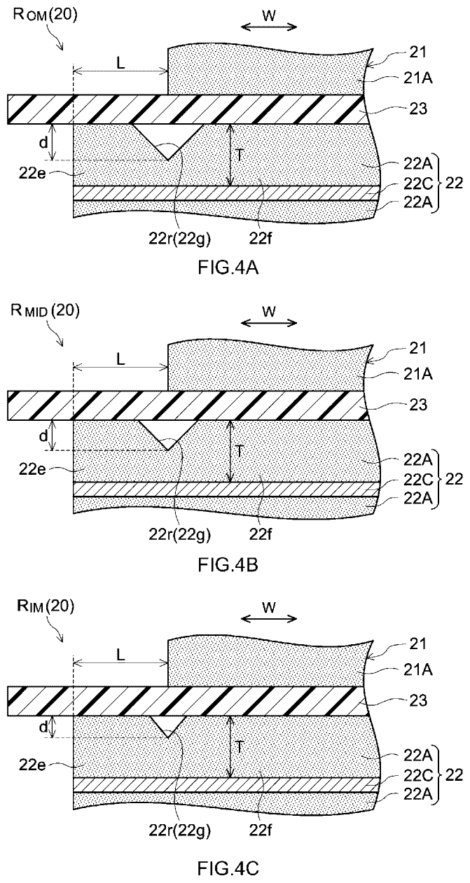

FIGS. 4A to 4C are enlarged schematic sectional views each illustrating the recessed portion 22r (groove portion 22g) of the anode active material layer 22A and its vicinity. Specifically, FIG. 4A shows the recessed portion 22r and its vicinity in the outermost peripheral region R_{OM} of the electrode body 20, which is a wound electrode body. FIG. 4B shows the recessed portion 22r and its vicinity in the middle region R_{MID} of the electrode body 20. FIG. 4C shows the recessed portion 22r and its vicinity in the innermost region R_{IM} of the electrode body 20. The middle region R_{MID} of the electrode body 20 refers to a region between the outermost region R_{OM} and the innermost region R_{IM} of the electrode body 20. In this embodiment, the middle region R_{MID} refers to a one-layer region (in a case that the number of the laminates between the outermost peripheral region R_{OM} and the innermost peripheral region R_{IM} is an odd number) or a two-layer region (in a case that the number of the laminates between the outermost peripheral region R_{OM} and the innermost peripheral region R_{IM} is an even number), which is separated from the outermost peripheral region R_{OM} and the innermost peripheral region R_{IM} by the same number of laminates.

The recess depth d (illustrated in FIG. 4A) of the recessed portion 22r (groove portion 22g) in the outermost peripheral region R_{OM} of the electrode body 20 is larger than the recess depth d (illustrated in FIG. 4C) of the recessed portion 22r (groove portion 22g) in the innermost peripheral region R_{IM} of the electrode body 20. This configuration has an advantage that the electrolytic solution is suppressed from leaking outside the electrode body 20 by retaining the electrolytic solution in the recessed portion 22r of the anode active material layer 22A in the outermost peripheral region R_{OM}, thereby suppressing high-rate degradation of the electrode body 20.

In this embodiment, the recess depth d (illustrated in FIG. 4A) of the recessed portion 22r (groove portion 22g) in the outermost peripheral region R_{OM} of the electrode body 20 is larger than the recess depth d (illustrated in FIG. 4B) of the recessed portion 22r (groove portion 22g) in the middle region R_{MID}. Further, the recess depth d (illustrated in FIG. 4C) of the recessed portion 22r (groove portion 22g) in the innermost peripheral region R_{IM} of the electrode body 20 is smaller than the recess depth d (illustrated in FIG. 4C) of the recessed portion 22r (groove portion 22g) in the middle region R_{MID}.

In this anode 22, according to this embodiment, the anode current collector 22C has multiple tabs 22t on the other end (the right end in FIG. 2) of the electrode body 20 or the anode 22 in the width direction W. In the anode current collector 22C, the tabs 22t are included in the exposed region where the anode active material layer 22A is not laminated. In the wound electrode body 20, the multiple tabs 22t are stacked in the laminating direction of the aforementioned layered structure of the electrode body 20 to form an anode tab portion 22T (illustrated in FIG. 1) (in the anode current collector 22c, the tabs 22t are provided in such an arrangement). The anode tab portion 22T functionally serves as a current collector portion in the anode 22. In this integrally stacked state, the tabs 22t are connected to anode current collection plates 60 (anode current collection plates 60 are provided on each anode tab portion 22T). Examples of a constituent material for the anode current collection plate 60 include copper and a copper alloy. Examples of the method for connecting the anode current collection plates 60 to the anode tab portion 22T in the anode 22 include ultrasonic joining and laser welding.

The separator 23 is intended to insulate between cathode active material layers 21A and the anode active material layers 22A while retaining an ion-conductive nonaqueous electrolytic solution between the both layers. A porous resin sheet made of a polyolefin resin is preferable as the separator 23. Examples of the polyolefin resin include polyethylene (PE) and polypropylene (PP). A heat resistance layer (HRL) containing an inorganic filler may be provided on the surface of the separator 23. Examples of a constituent material for the inorganic filler include alumina, boehmite, aluminum hydroxide, and titania.

In the electrode body 20 preparation process described above, a pressing step is performed after the aforementioned winding. Specifically, an elongated sheet-like laminate having the elongated sheet-like cathode 21, the elongated sheet-like separator 23, the elongated sheet-like anode 22, and an additional elongated sheet-like separator 23 arranged in this order is wound to form a wound body 20P, and then the wound body 20P is flattened by pressing as illustrated in FIG. 5 (pressing step). In the pressing step, for example, the wound body 20P is loaded (pressing pressure is applied) between a pair of press plates P1 and P2 of a press machine. By adjusting this pressing pressure, the wound body 20P can be flattened and the aforementioned recessed portion 22r can be formed to obtain the electrode body 20. Furthermore, by adjusting the pressing pressure and the aforementioned protrusion length L, the sizes (depth, width) of the recessed portion 22r can be adjusted. The pressing pressure in the pressing step is preferably 0.80 kN/cm² or higher, more preferably 0.90 kN/cm² or higher, even more preferably 1.00 kN/cm² or higher, and is preferably 1.80 kN/cm² or lower, more preferably 1.60 kN/cm² or lower, even more preferably 1.40 kN/cm² or lower.

In the battery 100, the cathode terminal 30 is attached to the case 10, as illustrated in FIG. 1. For example, the case 10 has a terminal opening portion that penetrates the constituent member (plate material) of the case 10 in the thickness direction, and the cathode terminal 30 is attached to this opening portion such that a gasket made of an insulating material is interposed between the cathode terminal 30 and the case 10. A method for attaching the cathode terminal 30 can be exemplified by caulking. Furthermore, the cathode terminal 30 is exposed to the outside and inside of the case 10. Inside the case 10, the cathode terminal 30 is connected to the cathode current collection plate 50. The cathode terminal 30 is electrically connected to the cathode 21 of the electrode body 20 via the cathode current collection plate 50. This cathode terminal 30 is preferably made of a metal, more preferably of aluminum or an aluminum alloy.

The anode terminal 40 is also attached to the case 10 (the attaching method is the same as described above for the cathode terminal 30). The anode terminal 40 is exposed to the outside and inside of the case 10. Inside the case 10, the anode terminal 40 is connected to the anode current collection plate 60. The anode terminal 40 is electrically connected to the anode 22 of the electrode body 20 via the anode current collection plate 60. This anode terminal 40 is preferably made of a metal, more preferably of copper or a copper alloy.

The nonaqueous electrolytic solution contains a nonaqueous solvent and an electrolyte (supporting salt). Examples of the nonaqueous solvent include ethylene carbonate (EC), propylene carbonate (PC), dimethyl carbonate (DMC), diethyl carbonate (DEC), and ethyl methyl carbonate (EMC). The nonaqueous solvent may be used alone or in combination with two or more types. The electrolyte is a lithium salt, preferably a fluorine-containing lithium salt. Examples of the fluorine-containing lithium salt include lithium hexafluorophosphate (LiPF₆), lithium tetrafluoroborate (LiBF₄), and lithium bis(fluorosulfonyl)imide (LiN(SO₂F)₂). The electrolyte may be used alone or in combination with two or more types. This nonaqueous electrolytic solution permeates the electrode body 20 in the case 10. Extra nonaqueous electrolytic solution not permeating the electrode body 20 may be stored in the case 10.

In the battery 100 having the configuration described above, the anode active material layer 22A in the anode 22 of the electrode body 20 includes a non-facing end portion 22e that does not face the cathode active material layer 21A via the separator 23, as described above. For ensuring a positional relationship where the entire area of the cathode active material layer 21A faces the anode active material layer 22A, it is suitable that the anode active material layer 22A further includes the non-facing end portion 22e outside the region t (facing portion 22f) hat faces the cathode active material layer 21A (this is suitable for ensuring the tolerance of the facing positional relationship between the anode active material layer 22A and the cathode active material layer 21A when winding deviation occurs in the electrode body 20, and thus helps to ensure the productivity of the electrode body 20 or the battery 100). Furthermore, for uniformizing Li ions inserted into the anode active material layer 22A during charging of the battery 100, it is suitable that the anode active material layer 22A further includes the non-facing end portion 22e outside the region (facing portion 22f) that faces the cathode active material layer 21A. Thus, this helps to suppress Li ions from precipitating in the anode active material layer 22A (when the edge of the anode active material layer is in the cathode active material layer-facing region, a density of the inserted Li ions tends to increase locally on this edge to enhance Li ion precipitation).

The anode active material layer has the recessed portion 22r where the surface of the anode active material layer 22A is apart from the separator 23 in the boundary region between the facing portion 22f and the non-facing end portion 22e, as described above. This configuration is suitable for narrowing the Li ion migration pathway from the facing portion 22f to the non-facing end portion 22e in the anode active material layer 22A to suppress diffusion of Li ions. Also, such suppression of the Li ion diffusion helps to suppress anode potential rise, thereby suppressing voltage drop due to self-discharge in the battery 100.

Furthermore, as for the recessed portion 22r of the anode active material layer 22A, the depth in the outermost peripheral region R_{OM} of the electrode body 20 (wound electrode body) is larger than the depth in the innermost peripheral region R_{IM}, as described above. According to this configuration, the electrolytic solution retention in the recessed portion 22r of the anode active material layer 22A in the outermost peripheral region R_{OM} suppresses the electrolytic solution from leaking outside the electrode body 20, thereby suppressing high-rate degradation of the electrode body 20.

As described above, the battery 100 is suitable for suppressing Li ion precipitation in the anode active material layer 22A, and suppressing Li ion diffusion from the facing portion 22f to the non-facing end portion 22e in the anode active material layer 22A and voltage drop due to self-discharge.

The battery 100 can be used for various applications. For example, the battery 100 can be suitably used as a power source (drive power source) for motors mounted in vehicles such as passenger vehicles and trucks. Examples of the vehicle type include, but are not limited to, plug-in hybrid electric vehicles (PHEV), hybrid electric vehicles (HEV), and battery electric vehicles (BEV).

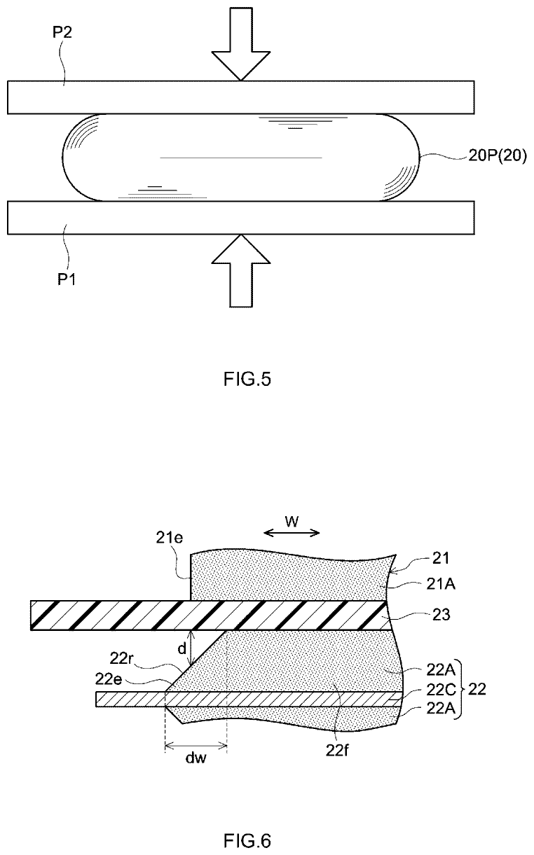

The recessed portion 22r of the anode active material layer 22A may have a shape other than the groove shape described above. FIG. 6 shows an example of another shape for the recessed portion 22r. The recessed portion 22r in FIG. 6 has an inclined shape. Specifically, this recessed portion 22r has an inclined shape where the surface of the anode active material layer 22A regresses from the separator 23 in the boundary region between the facing portion 22f and the non-facing end portion 22e of the anode active material layer 22A. As illustrated in FIG. 6, the depth d of the inclined recessed portion 22r refers to a regression length of the surface from a reference face, which is the surface of the facing portion 22f, at a position which faces the edge of the cathode active material layer 21A in the anode active material layer 22A. A width dw of the inclined recessed portion 22r refers to a dimension of the inclined surface in the width direction W of the anode 22. The recessed portion 22r may have such an inclined shape.

### TEST EXAMPLES

Test examples according to the present invention will be explained below, however, the present invention is not intended to be limited to the test examples.

### Example 1

### <Preparation of Cathode>

First, a cathode current collector, and a cathode slurry for forming a cathode active material layer were prepared. The cathode current collector is an elongated sheet-like aluminum foil (thickness: 13 μm). The cathode slurry was obtained by kneading a mixture containing a cathode active material (CAM), carbon black (CB) as a conductive material, and polyvinylidene fluoride (PVDF) as a binder in a mass ratio of CAM:CB:PVDF=97.5:1.5:1.0 and further containing a predetermined amount of N-methyl-2-pyrrolidone (NMP) as a solvent. A lithium-nickel-cobalt-manganese composite oxide (CAM) was used as a cathode active material. Subsequently, the cathode slurry was applied onto a predetermined region (strip-shaped) on one side of the cathode current collector (elongated sheet-shaped) to form a coating film, which was then dried. Subsequently, the cathode slurry was applied onto a predetermined region (strip-shaped) on the other side of the cathode current collector to form another coating film, which was then dried. Thereby, cathode active material layers (strip-shaped) were formed on both sides of the cathode current collector. Then, the cathode current collector having the cathode active material layer was rolled using a roller so that each of the cathode active material layers had a thickness of 60 μm. Subsequently, the cathode current collector having the cathode active material layer was cut out into a predetermined shape. As described above, the cathode sheet (cathode active material layer/cathode current collector/cathode active material layer) of Example 1 was prepared.

This cathode sheet has an edge (first edge) extending linearly over the entire longitudinal direction on one end in the width direction. The first edge is formed by linearly cutting out the cathode current collector and the cathode active material layers on its both sides in the longitudinal direction of the sheet. Furthermore, the cathode sheet has multiple tabs (tabs 21t in FIG. 2) spaced at predetermined intervals in the longitudinal direction on the other end in the width direction, and has an edge (second edge) extending linearly in the longitudinal direction between the tabs. In the width direction, the edge of the cathode active material layer (extending linearly in the longitudinal direction) is positioned apart from the second edge.

### <Fabrication of Anode>

First, an anode current collector and an anode slurry for forming an anode active material layer were prepared. The anode current collector is an elongated sheet-like copper foil (thickness: 8 μm). The anode slurry was obtained by kneading graphite as an anode active material (AAM), styrene-butadiene rubber (SBR) as a binder, and carboxymethylcellulose (CMC) as a thickener in a mass ratio of AAM:SBR:CMC=98.3:0.7:1.0 in an ion-exchanged water. Subsequently, the anode slurry was applied onto a predetermined region (strip-shaped) on one side of the anode current collector (elongated sheet-shaped) to form a coating film, which was then dried. Subsequently, the anode slurry was applied onto a predetermined region (strip-shaped) on the other side of the anode current collector to form another coating film, which was then dried. Thereby, anode active material layers (strip-shaped) were formed on both sides of the anode current collector. Then, the anode current collector having the anode active material layer was rolled using a roller so that each of the anode active material layers had a thickness T of 88 μm. Thereby, the density of the anode active material layer was 1.51 g/cm³. Subsequently, the anode current collector having the anode active material layer was cut out into a predetermined shape. As described above, the anode sheet (anode active material layer/anode current collector/anode active material layer) of Example 1 was prepared.

This anode sheet has multiple tabs (tabs 22T in FIG. 2) spaced at predetermined intervals in the longitudinal direction on one end in the width direction, and has an edge (first edge) extending linearly in the longitudinal direction between the tabs. Furthermore, the anode sheet has an edge (second edge) extending linearly over the entire longitudinal direction on the other end in the width direction. The first edge and second edge are each formed by linearly cutting out the anode current collector and the anode active material layers on both its sides in the sheet longitudinal direction.

### <Preparation of Electrode Body>

First, in addition to the aforementioned cathode sheet and anode sheet, elongated sheet-like separators (2 rolls) were prepared. The separator includes a resin porous substrate layer made of polyethylene (PE). Subsequently, an elongated sheet-like laminate with the cathode sheet, the separator, the anode sheet, and an additional separator arranged in this order was wound to obtain a wound body. The number of turns for the wound body was set to 33. In the width direction of the elongated sheet-like laminate, the first edge of the anode sheet on the anode tab side extended outward beyond the first edge (side without the cathode tab) of the cathode sheet. The anode active material layer had a non-facing end portion (non-facing end portion 22e in FIG. 3) that did not face the cathode active material layer via the separator. The protrusion length L of the non-facing end portion of the anode active material layer on the first edge side (anode tab side) was set to 1.4 mm. In the width direction of the elongated sheet-like laminate, the second edge of the anode sheet extended outward beyond the edge on the cathode tab side of the cathode active material layer of the cathode sheet. The anode active material layer had a non-facing end portion (non-facing end portion 22e in FIG. 3) that did not face the cathode active material layer via the separator. The protrusion length L of the non-facing end portion of the anode active material layer on the second edge side was set to 1.4 mm. Subsequently, in the pressing step, the wound body was pressed for 3 seconds to flatten it (see FIG. 5). In this pressing, the press load was set to 250 kN (pressing pressure: 1.08 kN/cm²). Thereby, a groove region (groove 22g in FIG. 3) was formed in the boundary region between the facing portion (facing portion 22f in FIG. 3) and the non-opposing end portion (non-facing end portion 22e in FIG. 3) on the anode active material layer. As described above, a flat wound electrode body of Example 1 was prepared.

### <Shape Measurement>

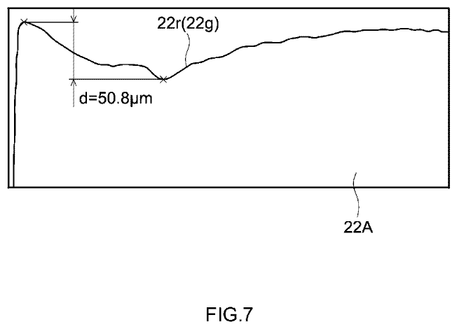

First, the wound electrode body was disassembled, and the anode sheet was taken out and unrolled in the longitudinal direction. For this anode sheet, it was visually confirmed that a groove portion (groove portion 22g in FIG. 3) was formed in the boundary region between the facing portion and the non-facing end portion of the anode active material layer over a region from the winding starting end (innermost peripheral side of the wound electrode body) to the winding ending end (outermost peripheral side of the wound electrode body). Subsequently, the size of the groove portions were measured using a 3D shape measuring machine (product name: “VR-5000”, manufactured by KEYENCE CORPORATION). Specifically, in the wound electrode body, a depth d and a width were measured for the groove portion on the first edge side (anode tab side) and the groove portion on the second edge side in the outermost peripheral region, the groove portion on the first edge side (anode tab side) and the groove portion on the second edge side in the middle region, and the groove portion on the first edge side (anode tab side) and the groove portion on the second edge side in the innermost peripheral region. The results are presented in Table 1. Table 1 also presents a ratio (d/T) of the depth d (μm) to the thickness T (μm) of the anode active material layer. As an example of shape measurement results obtained using the 3D shape measuring machine, FIG. 7 shows image data obtained for the non-facing end portion and its vicinity of the anode active material layer on the first edge side in the outermost peripheral region of the wound electrode body in Example 1. In the image data of FIG. 7, the depth and width of the recessed portion (groove portion) on the first edge side in the anode active material layer were determined.

### Example 2

A wound electrode body of Example 2 was prepared in the same manner as for the wound electrode body of Example 1, except that the pressing pressure applied to the wound electrode body in the aforementioned pressing step was set to 350 kN (pressing pressure: 1.51 kN/cm²), and an inclined recessed portion (recessed portion 22r in FIG. 6) was formed on the boundary region between the facing portion (facing portion 22f in FIG. 6) and the non-facing end portion (non-facing end portion 22e in FIG. 6) in the anode active material layer within the outermost peripheral region of the wound electrode body. Subsequently, as described above for Example 1, the wound electrode body was disassembled, and the anode sheet was taken out. For the anode sheet, the size of the recessed portion was measured using the 3D shape measuring machine. The results are presented in Table 1.

### Example 3

A wound electrode body of Example 3 was prepared in the same manner as for the wound electrode body of Example 1, except that the pressing pressure applied to the wound electrode body in the aforementioned pressing step was set to 125 kN (pressing pressure: 0.54 kN/cm²), thereby not forming the recessed portion. Subsequently, the wound electrode body was disassembled, and the anode sheet was taken out. For this anode sheet, shapes of the same measurement sites as described above for Example 1 were measured using the 3D shape measuring machine. The results are presented in Table 1.

TABLE 1

| | | | Protrusion | Recessed portion | | | | | | | | |
|---|---|---|---|---|---|---|---|---|---|---|---|---|
| | | | length L of | Outermost peripheral | | | | | | Innermost peripheral | | |
| | | | non-facing | region | | | Middle region | | | region | | |
| | | Pressing | end | Depth | Depth | | Depth | Depth | | Depth | Depth | |
| | | pressure | portion | d | ratio | Width | d | ratio | Width | d | ratio | Width |
| | | (kN/cm²) | (mm) | (μm) | (d/T) | (mm) | (μm) | (d/T) | (mm) | (μm) | (d/T) | (mm) |
| Example | First edge side of | 1.08 | 1.4 | 50.8 | 0.58 | 2.0 | 14.2 | 0.16 | 2.0 | 6.2 | 0.07 | 2.0 |
| 1 | anode (tab side) | | | | | | | | | | | |
| | Second edge side | | 2.2 | 23.8 | 0.27 | 1.1 | 16.7 | 0.19 | 1.1 | 3.9 | 0.04 | 1.1 |
| | of anode | | | | | | | | | | | |
| Example | First edge side of | 1.51 | 1.4 | 88.0 | 1.00 | 3.0 | 24.6 | 0.28 | 3.0 | 10.7 | 0.12 | 3.0 |
| 2 | anode (tab side) | | | | | | | | | | | |
| | Second edge side | | 2.2 | 41.2 | 0.47 | 1.4 | 28.9 | 0.33 | 1.4 | 6.8 | 0.08 | 1.4 |
| | of anode | | | | | | | | | | | |
| Example | First edge side of | 0.54 | 2.0 | 0 | 0 | 0 | 0 | 0 | 0 | 0 | 0 | 0 |
| 3 | anode (tab side) | | | | | | | | | | | |
| | Second edge side | | 1.8 | 0 | 0 | 0 | 0 | 0 | 0 | 0 | 0 | 0 |
| | of anode | | | | | | | | | | | |

The battery disclosed herein may be any secondary battery other than lithium ion secondary batteries. Examples of the secondary battery include not only batteries commonly referred to as lithium ion batteries or lithium secondary batteries but also batteries such as nickel-metal hydride batteries.

As described above, the specific aspects of the technology disclosed herein include configurations described in each item below.

### Item 1:

A secondary battery including:
a wound electrode body, in which
the wound electrode body includes a strip-like cathode, a strip-like anode, and a strip-like separator, with the cathode and anode wound in a longitudinal direction via the separator,
the cathode has a laminated structure including a cathode current collector and a cathode active material layer,
the anode has a laminated structure including an anode current collector and an anode active material layer,
the anode active material layer includes:
   a facing portion that faces the cathode active material layer via the separator; and
   a non-facing end portion that does not faces the cathode active material layer via the separator,
the anode active material layer has a recessed portion where a surface of the anode active material layer is regressed from the separator in a boundary region between the facing portion and the non-facing end portion, and
in the anode active material layer, a recess depth of the recessed portion in an outermost peripheral region of the wound electrode body is larger than a recess depth of the recessed portion in an innermost peripheral region of the wound electrode body.

### Item 2:

The secondary battery according to Item 1, in which the recessed portion is a groove portion.

### Item 3:

The secondary battery according to Item 2, in which the groove portion has a depth of 1 to 70 μm.

### Item 4:

The secondary battery according to Item 2 or 3, in which the groove portion has a width of 0.3 to 3.5 mm.

### Item 5:

The secondary battery according to any one of items 2 to 4, in which a ratio of the depth of the groove portion to a thickness of the wound electrode body in the outermost peripheral region is 0.02 to 0.70 in the anode active material layer.

### Item 6:

The secondary battery according to any one of Items 1 to 5, in which a density of the anode active material layer is 1.0 to 2.0 g/cm³.

### Item 7:

The secondary battery according to any one of Items 1 to 6, in which the anode active material layer has an average thickness of 50 to 200 μm.

The specific examples of the present invention have been explained in detail above, but these examples are merely illustrative and do not limit the scope of claims. The technology described in claims includes variations and modifications of the specific examples illustrated above.

What is claimed is:

1. A secondary battery comprising:
a wound electrode body, wherein
the wound electrode body comprises a strip-like cathode, a strip-like anode, and a strip-like separator, with the cathode and anode wound in a longitudinal direction via the separator,
the cathode has a laminated structure comprising a cathode current collector and a cathode active material layer,
the anode has a laminated structure comprising an anode current collector and an anode active material layer,
the anode active material layer comprises:
a facing portion that faces the cathode active material layer via the separator; and
a non-facing end portion that does not faces the cathode active material layer via the separator,
the anode active material layer has a recessed portion where a surface of the anode active material layer being regressed from the separator in a boundary region between the facing portion and the non-facing end portion, and
in the anode active material layer, a recess depth of the recessed portion in an outermost peripheral region of the wound electrode body is larger than a recess depth of the recessed portion in an innermost peripheral region of the wound electrode body.

2. The secondary battery according to claim 1, wherein the recessed portion is a groove portion.

3. The secondary battery according to claim 2, wherein the groove portion has a depth of 1 to 70 μm.

4. The secondary battery according to claim 2, wherein the groove portion has a width of 0.3 to 3.5 mm.

5. The secondary battery according to claim 2, wherein a ratio of the depth of the groove portion to a thickness of the anode active material layer is 0.02 to 0.70.

6. The secondary battery according to claim 1, wherein a density of the anode active material layer is 1.0 to 2.0 g/cm³.

7. The secondary battery according to claim 1, wherein the anode active material layer has a thickness of 50 to 200 μm.
